(19) United States
(12) Patent Application Publication
(10) Pub. No.: US 2008/0300915 A1
(43) Pub. Date: Dec. 4, 2008

(54) System and Method for Providing Informed Consent

(76) Inventors: Ernesto P. Molmenti, Tucson, AZ (US); Frederic N.C. Smalkin, Baltimore, MD (US)

Correspondence Address: LAWRENCE R. OREMLAND, P.C., 5055 E. BROADWAY BLVD., SUITE C-214, TUCSON, AZ, 85711, US

(21) Appl. No.: 11/755,489

(22) Filed: May 30, 2007

(51) Int. Cl. G06Q 50/00

(52) U.S. Cl. 705/2

(57) ABSTRACT

A system and method of providing subject informed consent in connection with a medical procedure is provided. According to the invention, a subject interfaces electronically with an electronic consent component that (i) provides the subject with information concerning a medical procedure, (ii) electronically enables the subject to provide an informed consent to the medical procedure, (iii) electronically stores as a medical record for the medical procedure the substance of the informed consent to the medical procedure provided by the subject and the manner in which the informed consent was obtained, such that the subject's medical record can be retrieved during a timeout in the medical procedure, and (iv) enables an authorized person who is seeking to review the subject's medical record to access the electronically stored medical record in a manner that documents the authorized person's access of the stored medical record and produces information as to the stored medical record.

### BACKGROUND

The present invention relates to a new and useful system and method for providing informed consent in connection with a medical procedure.

In certain surgical, medical, dental, and even veterinary procedures, local law and/or the prevailing standard of care require the responsible practitioner to obtain the “informed consent” of the subject, i.e. the patient or other responsible party (e.g., parent, guardian, or animal owner)). In current practice, this is primarily accomplished by utilizing a preprinted, paper “informed consent form,” which is read to or by the subject. If read to the subject (preferred method), this requires the practitioner to spend valuable time reading often tedious informed consent narratives to subjects. In practice, because of time demands on the practitioner, obtaining informed consent is often delegated to an adjunct (i.e., another (usually junior) practitioner or nurse or clerk), thus not insuring that a legally and medically sufficient informed consent is obtained, and/or that there is a reliable record of what transpired in the process. Nonetheless, the practitioner him/her self remains responsible. In other cases, even where the practitioner him/her self gives the narrative, the oral interchange may not be accurately recorded or easily proved in the event of litigation.

### SUMMARY OF THE INVENTION

The present invention provides a system and method of providing subject informed consent in connection with a medical procedure. According to the invention, a subject interfaces electronically with an electronic consent component that (i) provides the subject with information concerning a medical procedure, (ii) electronically enables the subject to provide an informed consent to the medical procedure, (iii) electronically stores as a medical record for the medical procedure the substance of the informed consent to the medical procedure provided by the subject and documents the manner in which the informed consent was obtained, such that the subject's medical record can be retrieved during a timeout in the medical procedure, and (iv) enables an authorized person who is seeking to review the subject's medical record to access the electronically stored medical record in a manner that documents the authorized person's access of the stored medical record and produces information as to the stored medical record.

When the principles of the present invention are being used in connection with a medical procedure, a medical personnel can selectively interface with the electronic consent component at least at any (or all) of the following points related to the medical procedure: (a) when the subject is admitted to the facility at which the medical procedure will be performed, (b) during a timeout while the subject is being prepared for the medical procedure, (c) during a timeout prior to the subject undergoing the medical procedure.

Preferably, the medical record is produced by selective interface with the subject and the electronic consent component in the following manner:
a. the subject interfaces with the electronic consent component in a manner that enables the subject to receive and view electronically stored informed consent data related to a medical procedure in an electronically accessible format. The informed consent data is designed to provide (present) the subject with the type of information that will allow the subject to understand the nature of the medical procedure.
b. the subject electronically interfaces with the electronic consent component in a manner that enables the subject to (i) electronically acknowledge the informed consent data that has been received and reviewed by the subject with regard to the medical procedure, and (ii) electronically provide an informed consent by the subject to the procedure (or to revoke a previously given consent to the procedure). The system then electronically stores as a medical record the substance of the informed consent provided by the subject and documents the manner in which the informed consent was obtained. The stored medical record of the subject is then selectively accessible by an authorized person seeking to review the subject's medical record in connection with the medical procedure.

One objective of the system and method of the present invention is to optimize the amount of information provided to a subject prior to a potential medical procedure. Human fatigue, distractions, and errors both on the side of the provider and subject (especially a subject who will be the direct recipient of the medical procedure) are frequent findings. With the present invention, the information can be accessed on multiple occasions not only by the intended subject but also by other individuals that he/she may designate, or who need to approve the medical procedure for the subject. Once the information has been thoroughly evaluated by the subject, specific points could be addressed during a personal encounter between the subject and medical personnel.

Another objective of the system and method of the present invention is to standardize and document the process and information by which the subject provided informed consent to a medical procedure, thereby to enhance the reliability of the process, and the legal sufficiency of the medical record in documenting that process.

Another objective of the system and method of the present invention is to provide a lean system with diminished waste of time and decreased anxiety. For example, the system and method of the present invention includes a presentation that can be provided to the subject that enables the subject to become familiar with the environment in which the medical procedure will take place (e.g. the preparation facilities and operating room in the case of a surgical procedure), and the medical personnel who will be involved in the medical procedure. This aspect can reduce some of the subject's anxiety about the medical procedure and can optimize resources of both the provider and the subject, by enabling the subject to become familiar with the environment prior to the time of the medical procedure. Delays in operating room starting time associated with physicians not being prompt, as well as anxiety on the part of subjects, could be minimized.

Still another objective of the system and method of the present invention is to provide for a system with diminished variability and decreased variance within it, and thus decreased potential for mistakes. By standardizing the information, the present invention allows for a decreased incidence of exclusions of necessary data. Aspects specific to each case could subsequently be addressed in an individual basis.

Other features of the present invention will become further apparent from the following detailed description and the accompanying drawings.

### BRIEF DESCRIPTION OF THE DRAWINGS

FIG. 1 is a schematic illustration of an electronic consent component for a system and method according to the present invention; and

FIG. 2 is a schematic illustration of the manner in which the system and method of the present invention would be provided in connection with a medical procedure.

### DETAILED DESCRIPTION

As discussed above, the present invention relates to a new and useful system and method for providing informed consent in connection with a medical procedure. In the following detailed description, the principles of the present invention are described in connection with a kidney transplant procedure, but from that description, the manner in which the principles of the present invention can be applied to various medical procedures will become apparent to those in the art.

### Definitions:

A “subject” would be the object (human, animal, cadaver, etc) who (that) is to undergo (receive) the procedure, and that subject's guardian(s), or anyone else who can approve the procedure for the subject.

A “medical procedure” is any procedure (invasive or non invasive, experimental or non experimental) by which a subject may be medically treated, (e.g. surgically, by administration of a pharmaceutical, removal of an organ from a cadaver or from a live donor, by a blood transfusion, etc.).

The different “formats” of the information provided to a subject would be the different ways (e.g. text, audio, video, audio/visual, graphical, etc.) by which the information can be presented to the subject.

The term “medical personnel” means anyone who is involved with the medical procedure (e.g. anyone who admits the subject to a hospital or other facility where the procedure will be performed, anyone involved in preparing the subject for the procedure, any attending physician, nurse, anesthetist, pathologist, veterinarian, dentist, or anyone else in the operating room or other place where the procedure will be performed, any administrator of the facility, social worker, anyone involved with the subject's post procedure physical or emotional care, etc.).

A “timeout” in connection with a medical procedure is a commonly used term that means a period in which someone with an interest in the medical procedure (physician, nurse, administrator, or other medical personnel) would have the opportunity to review (or would be expected to review) information concerning the subject and/or the medical procedure.

An electronic “component” can be one or more electronic elements that perform the function associated with the component.

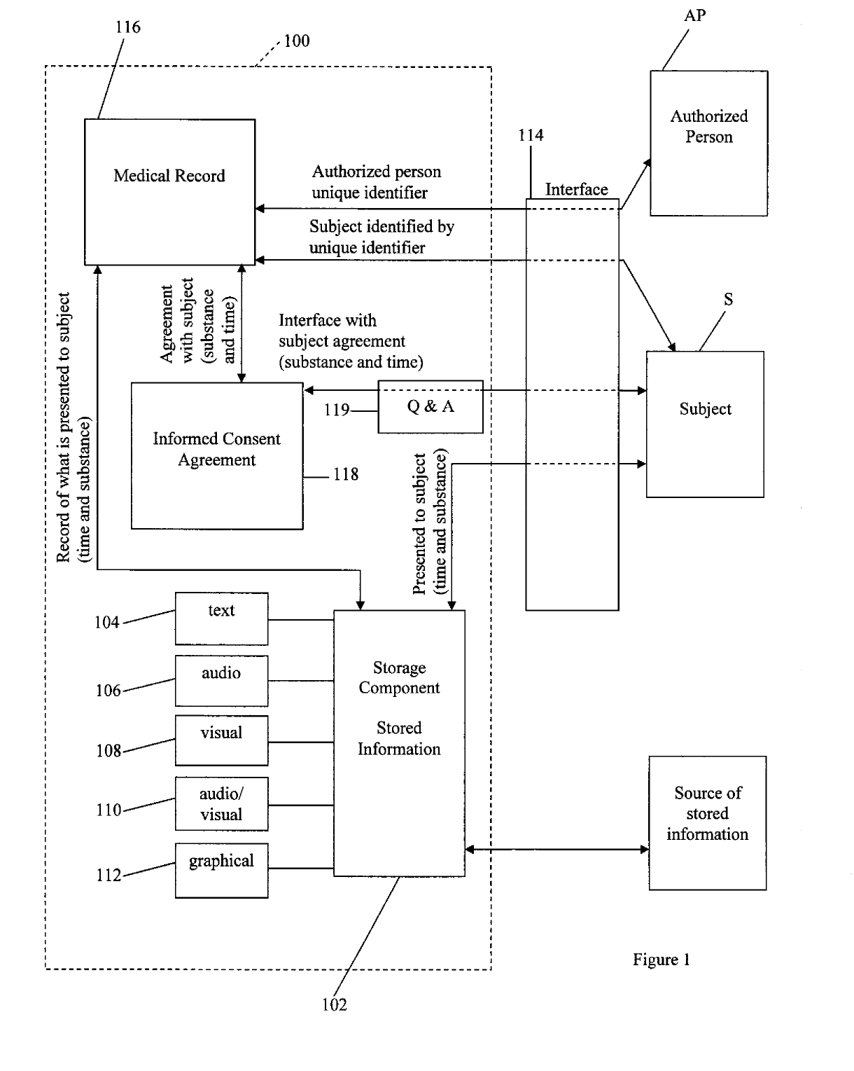

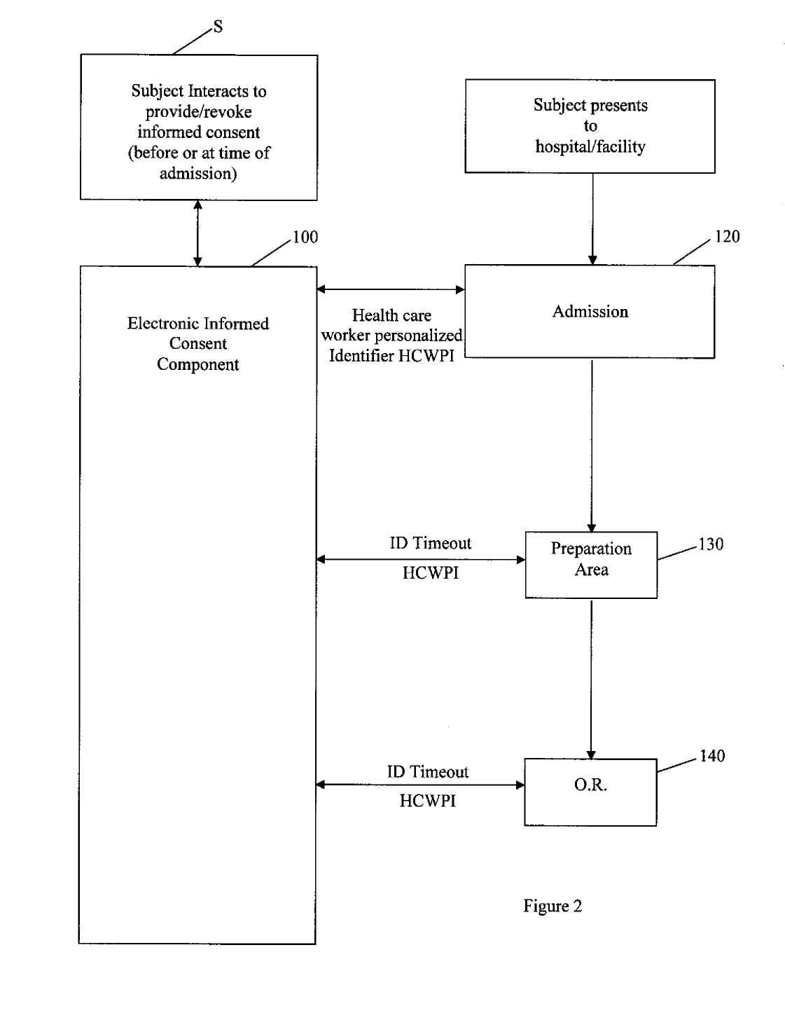

The system and method of the present invention can be understood from the following description and the accompanying Figures. FIG. 2 schematically illustrates the manner in which the system and method of the present invention would be provided in connection with a medical procedure, using an electronic consent component 100 that is schematically illustrated in FIG. 1.

The subject (identified as “S” in the Figures) initially interfaces electronically with the electronic consent component 100, to learn more about the procedure that is being proposed for the subject. The electronic consent component 100 provides the subject with information concerning a medical procedure (e.g. (i) by allowing the subject to select the type of information the subject wants to review, (ii) by continuously (and repeatedly) providing a presentation that resides in the electronic consent component, in a room or other facility where the subject is located), so that the subject has an opportunity to either review a presentation that resides in the system, or select the material that the subject wants to review. Information that is stored in a storage component 102 can be continuously played for the subject, or the subject can select the information the subject wants to review. Such information can be presented to the subject at a computer terminal, at the subject's home or residence via the internet, or in a waiting room while the subject is waiting to see a medical personnel. The information provided to the subject from the electronic storage component 102 can be, e.g., in various formats such as text 104, audio 106, video 108, audio/visual 110, graphical 112, etc.

An example of the type of text information that can be presented to the subject in connection with a kidney transplant is shown in Exhibit A.

Also, the information that is presented to the subject can be information about the facility at which the procedure will be performed, the medical personnel who will be with the subject during the medical procedure, or other information that is designed to both provide the subject with the type of information believed important for the subject to have in order to make an informed consent to the medical procedure, and also to relieve at least some of the subject's anxiety about the procedure by providing the subject with information about the facility and/or the medical personnel.

The electronic consent component 100 can be a stand alone computer that can have an interface 114 with a subject S (e.g. via a screen, keyboard, input/output, etc of the computer, a terminal on a network of the facility at which the medical procedure will be performed, the subject's home computer (e.g. via the internet)). In any such system, the subject would have a unique identifier (e.g user name and password) that is always associated with the subject, and by which the subject can be authenticated to the electronic consent component 100 in order to allow the subject to interface with the electronic consent component. The electronic consent component 100 would run a database program such as Oracle or SQL that can (i) store information in the various formats that will be presented to the subject, and (ii) record information provided by the subject as a medical record that is connected with the subject's unique identifier, and which can have a front end (e.g. written in Visual Basic) that is part of the interface 114 and enables the electronic consent component to track, record and store all interactions between an authorized person and the electronic consent component.

The information that is provided to the subject is designed to be medically sufficient information that has been determined by experienced medical personnel to be sufficient to enable a subject to provide informed consent to the medical procedure. Such information may be presented in various formats (e.g. text, audio, visual, audio/visual), and is preferably generated from experts and/or experienced surgeons/physicians/veterinarians to provide their collective wisdom as to what constitutes medically sufficient information. Also, it is contemplated that the information may be changed from time to time, as additional information is added to the system, or as standards of medically sufficient information change.

The information provided to the subject from the storage component 102 is designed to enable the subject to provide an informed consent to the medical procedure, and the electronic consent component 100 is configured to electronically store (and document) that informed consent as a medical record 116 associated with the subject's unique identifier. Also, the electronic consent component 100 is designed such that whenever a subject S provides an informed consent entry to a medical procedure, the electronic consent component records the actual consent language (document) to which the subject agreed, as well as the information that the subject reviewed in connection with the informed consent. Thus, if the subject selected and reviewed certain information in the storage component 102, the date and time the information was reviewed, the nature of what was reviewed would be recorded, against the subject's unique identifier. Also, if the system is designed to continuously (and repeatedly) play certain information, and the subject is in the environment where the information is being played, the subject would sign into the environment with the subject's unique identifier, so that there would be a record that the subject was in the environment where the information was being presented.

When the subject has consented to the medical procedure, the electronic consent component 100 electronically stores as a medical record for the medical procedure the substance of the informed consent to the medical procedure provided by the subject and the manner in which the informed consent was obtained, such that the subject's medical record can be retrieved during a timeout in the medical procedure. That stored medical record is accessible to an authorized person (e.g AP in FIG. 1, or a Health Care worker personal identifier, HCWPI in FIG. 2) who is seeking to review the subject's medical record (e.g. during a medical timeout). Moreover, for an authorized person to access the medical record, the authorized person would have his/her own unique identifier, and the system would document the authorized person's access of the stored medical record and would also document any modification made by that authorized person to the medical record.

When the principles of the present invention are being used in connection with a medical procedure, a medical personnel can selectively interface with the electronic consent component at least at any (or all) of the following points related to the medical procedure: (a) when the subject is admitted to the facility at which the medical procedure will be performed (shown schematically at 120 in FIG. 2), (b) during a timeout while the subject is being prepared for the medical procedure (shown at 130 in FIG. 2), (c) during a timeout prior to the subject undergoing the medical procedure (shown as a time out when the subject is in the operating room 140 in FIG. 2).

The following example describes the manner in which a subject may interact with the electronic consent component 100 (ECC)
a. The subject S initiates an interaction with the ECC 100 by presenting the subject's unique identifier to the ECC.
b. Once an interaction with the ECC begins, the subject's unique identifier, the date and time of the interaction, the nature of the medical procedure that is the subject of the interaction, and the nature of the subject's interaction with the ECC are “trapped” (i.e. recorded by the ECC as part of the subject's medical record 116).
c. The initial interaction may be a presentation of information to the subject regarding the medical procedure, designed to provide the subject with sufficient information to enable the subject to provide an informed consent to the procedure. The interaction can include e.g. a prepared presentation that the ECC plays for the subject regarding the medical procedure (once the subject initiates the interaction), or a presentation that enables the subject to select the nature and form of the presentation (e.g. via a menu). The interaction can be “trapped” in part by electronic pointers to the locations in the storage component 102 where the information that is reviewed by the subject can be found.
d. The subject can also initiate an interaction with the ECC in order to review and approve the subject's informed consent to the medical procedure. This can be in a separate interaction, that the subject initiates with the subject's unique identifier, or it can be part of the interaction in which the subject is presented with information regarding the medical procedure. As part of such an interaction, the subject would interact with an informed consent agreement component 118, and the subject would be presented with the informed consent agreement language needed for the medical procedure, the subject would be asked to acknowledge that the subject has had an opportunity to review information regarding the medical procedure and the informed consent agreement language, and to electronically agree to the medical procedure. In addition, the electronic consent component 100 may have a ‘question/answer” component 119 as part of the interface between the subject and the informed consent component 118. The “question/answer” component 119 enables the subject to present questions before giving informed consent, and to get those questions answered by appropriate medical personnel before giving informed consent to the medical procedure. The subject's questions would be presented to the “question/answer” component 119, and stored there until appropriate medical personnel respond to a “calling” that alerts the medical personnel that a question from the subject is pending and must be responded to before the subject can provide informed consent to the medical procedure. The subject's unique identifier, the date and time of the subject's interaction with the electronic consent component 100, the nature of the informed consent agreement reviewed by the subject, the questions asked by the subject and the response of medical personnel to those questions, the subject's acknowledgement of what was reviewed, and the subject's agreement to the medical procedure would all be “trapped” and recorded as part of the subject's medical record 116.
e. The subject's medical record in the ECC can be accessed by an authorized medical personnel, via the Health care worker personalized identifier (HCWPI in FIG. 2). The HCWPI enables that medical personnel to access the subject's medical record 116. When that authorized medical personnel accesses the subject's medical record, the ECC 100 traps the authorized medical personnel's unique identifier, the unique identifier of the subject associated with the medical record, the date and time of the access, the nature of what was accessed in the medical record, and any modifications made to the medical record during that access.
f. There may also be a need for an authorized person AP who is other than a medical personnel to access the subject's medical record 116. For example, if the subject's medical record needed to be accessed during a legal proceeding, the authorized person AP accessing the medical record would need a unique identifier that would enable that person to access the subject's medical record, and the subject's unique identifier would also be required to enable that AP to access the subject's medical record. When that authorized person accesses the subject's medical record, the system traps the authorized person's unique identifier, the unique identifier of the subject associated with the medical record, the date and time of the access, the nature of what was accessed in the medical record, and any modifications to the medical record made during that access.

The electronic consent component 100 can be implemented on a computer, server, or other electronic device capable of running a SQL or Oracle database (those databases are suitable because they are capable of handling the different formats of the information that may be presented to the subject according to the present invention), and the front end interface between the ECC 100 and the subject is preferably in code written in Visual Basic, to trap the information that is to be part of a subject's medical record. The electronic consent component is associated with a display that facilitates presentation of the information to the subject, and otherwise interfaces the subject (or authorized person) with the electronic consent component

Thus, as seen from the foregoing description, the medical record is produced by selective interface with the subject and the electronic consent component in the following manner:
a. the subject S interfaces with the electronic consent component 100 in a manner that enables the subject to receive and view electronically stored informed consent information related to a medical procedure in an electronically accessible format. The informed consent information is designed to provide the subject with the type of information that will allow the subject to understand the nature of the medical procedure.
b. the subject electronically interfaces with the electronic consent component in a manner that enables the subject to (i) electronically acknowledge the informed consent information that has been received and reviewed by the subject with regard to the medical procedure, (ii) electronically provide an informed consent by the subject to the procedure (or to revoke a previously given consent to the procedure), and (iii) electronically store as a medical record 116 the substance of the informed consent provided by the subject and document the manner in which the informed consent was obtained.

The stored medical record of the subject is then selectively accessible by an authorized person (AP or HCWPI) seeking to review the subject's medical record in connection with the medical procedure.

The electronic consent component 100 comprises
a. the electronic storage component 102 containing information related to the medical procedure in a plurality of electronically accessible formats,
b. an electronic transmission/presentation component (e.g the interface 114 by which the subject interacts with the ECC) that enables a subject to electronically receive and view the information related to a medical procedure in at least one selected format,
c. an electronic acknowledgement/agreement component (e.g. the informed consent agreement component 118, its electronic connection to the medical record 116, and the interface 114) that enables a subject to electronically (i) acknowledge the informed consent information that has been received and reviewed by the patient with regard to the medical procedure and (ii) provide an informed consent by the subject to the procedure,
d. an electronic storage component (i.e. the medical record portion 116 of the ECC) that electronically receives and stores as a medical record the subject's acknowledgement of the informed consent data that has been reviewed by the subject in regard to the medical procedure and the subject's agreement to the medical procedure, and
e. a unique identifier for each subject in the system, that electronically connects each patient with the subject's medical record 116 and with each of components a-d for that subject.

Also, the electronic consent component 100 (e.g the medical record 116 that is accessable via the interface 114) is accessible via a unique identifier for each medical personnel (AP, HCWPI) who accesses the electronic consent component during a timeout in the medical procedure, and wherein the electronic consent component is configured to receive and store information concerning access and/or display of a subject's medical record by each such medical personnel or other authorized person.

As illustrated in FIG. 1, the method of the present invention contemplates that during a medical procedure (e.g. a transplant operation) medical personnel may access the ECC to review the subject's medical record at least at any or all of the following points related to the medical procedure:
a. when the subject is admitted to the facility (hospital) at which the medical procedure will be performed,
b. during a timeout while the subject is being prepared for the medical procedure,
c. during a timeout prior to the subject undergoing the medical procedure (transplant).

The invention described in this application is an improvement over current practice for obtaining informed consent. The invention is a method or system for originating, compiling, distributing to participating practitioners and/or institutions, and displaying for the patient, informed consent information (e.g a collection of “informed consent narratives”) using multiple media (i.e., writing and/or analog or digital electronic media or formats, e.g., audio, video, text, audio/visual or graphics, including still images, illustrations, and/or animation), and tailored to cover the widest possible range of surgical, medical, dental, or veterinary procedures for which “informed consent” is required by law, by custom, or by the standard of medical care prevailing in the locality where the procedure is to be performed, including, but not limited to: inpatient and outpatient surgical and/or diagnostic procedures, including invasive and noninvasive techniques, involving the human mind or body or any part thereof or an animal's body; examinations of the body or any part or organ thereof; biopsies; dental or oral surgery; podiatry; chiropractic manipulation; and/or any other medical, psychiatric, dental or veterinary procedure, treatment, or examination of any description whatsoever involving informed consent. The informed consent narratives would be compiled utilizing medical/dental/veterinary practitioners skilled in their respective arts, would be generally validated by lawyers skilled in their art, and could further be validated and tailored by lawyers to conform to local law and/or practice pertaining to the geographical situs involved. The narratives could be prepared in any desired language or even specially enhanced for the handicapped.

Individual narratives or the entire compilation would ideally be made and maintained in cooperation with medical/dental/veterinary schools or institutions of high standing and/or recognized specialist medical/dental/veterinary boards or societies, to increase reliability and marketability. The presentation of these narratives via the ECC could be made by a number of means, such as by textual presentations, audio presentation, visual presentations, audio/visual presentations, graphical presentations, ete. The ECC may be accessible over the internet by downloading or streaming media, or even by means of an on-site network with its own library or connection to a central library, and/or handheld devices that could download, store, and present the information to subjects (and other parties) or allow them to access the presentations via a wireless network. As technology permits, means may be included whereby the subject could view other or different stored or transmitted information and/or entertainment with such a device. Provision would be made for reviewing and updating the presentations, as necessary (e.g., to stay current with medical advances and/or legal decisions), ideally with automatic notice and/or distribution of updates to subscribing practitioners and facilities.

The system and method of the present invention provides the following useful features

#1—Optimize the amount of information provided to subjects prior to potential procedures. Human fatigue, distractions, and errors both on the side of the provider and subject are frequent findings. With the system and method of the present invention, the information could be accessed on multiple occasions not only by the intended subject but also by other individuals that he/she may designate. Once the material has been thoroughly evaluated, specific points could be addressed during a personal encounter.
#2—Provide for a lean system with diminished waste of time and decreased anxiety. By becoming familiar with a procedure prior to the intended intervention, the amount of time saved would allow for an optimization of resources on the side of both the provider and the recipient. Delays in operating room starting time associated with physicians not being prompt, as well as anxiety on the part of subjects, could be minimized.
#3—Provide for a system with diminished variability and decreased variance within it, and thus decreased potential for mistakes. By standardizing the information, the system and method of the present invention allows for a decreased incidence of exclusions of necessary data. Aspects specific to each case could subsequently be addressed in an individual basis.

In addition, it will be clear to those in the art that the informed consent concepts provided by this invention may be used at various levels of subjects. Clearly, a subject who is to be the recipient of a medical procedure would use the system and method concepts of this invention, in providing informed consent to the procedure. In addition, in the case of a donor (e.g. an organ donor, the subject that can authorize removal of an organ from a cadaver, a blood donor, etc), it may be necessary or desirable for the donor to interact with the system of the invention, to provide an informed consent to the donation of biological material from that donor. It will also be clear to those in the art that if a medical procedure involves different stages, each of which requires informed consent (e.g. informed consent to a blood transfusion, informed consent to admistration of anbiotics, etc.) the system and method of the present invention can be operated such that informed consent is provided at each stage at which informed consent is required.

With the foregoing disclosure in mind, it is believed that various adaptations of a system and method for providing informed consent to a medical procedure, according to the principles of the present invention, will be apparent to those in the art.

1. An electronic system for providing subject informed consent in connection with a medical procedure, comprising
a. an electronic consent component that electronically (i) presents a subject with information concerning a medical procedure, (ii) enables the subject to provide an informed consent to the medical procedure, and (iii) stores as a medical record for the medical procedure the substance of the informed consent to the medical procedure provided by the subject and documents the manner in which the informed consent was obtained, such that the subject's medical record can be retrieved during a timeout in the medical procedure; and
b. the electronic consent component being selectively accessible by an authorized person who is seeking to review the subject's medical record for the medical procedure.

2. The electronic system of claim 1, wherein the electronic consent component comprises
a. an electronic storage component containing informed consent data related to the medical procedure in a plurality of electronically accessible formats,
b. an electronic transmission/presentation component that enables a subject to electronically receive and view informed consent information related to a medical procedure in at least one selected format,
c. an electronic informed consent agreement component that enables a subject to electronically (i) acknowledge the informed consent data that has been received and reviewed by the subject with regard to the medical procedure and (ii) provide an informed consent by the subject to the procedure,
d. an electronic storage component that electronically receives and stores as a medical record the subject's acknowledgement of the informed consent data that has been reviewed by the subject in regard to the medical procedure and the subject's agreement to the medical procedure,
e. an electronic retrieval and display component that is selectively accessible by an authorized person who is seeking to review the subject's medical record for the medical procedure, and
f. a unique subject identifier for each subject in the system, that electronically connects each subject with the subject's medical record and with each of components a-e for that patient.

3. The system of claim 2, wherein the electronic retrieval and display component is accessible via a unique identifier for each medical personnel who accesses the electronic retrieval and display component during a timeout in the medical procedure, and wherein the electronic storage component is configured to receive and store information concerning access and/or display of a subject's medical record by each such medical personnel.

4. A method of providing subject informed consent in connection with a medical procedure, comprising
a. enabling a subject to selectively interface electronically with an electronic consent component that (i) provides the subject with information concerning a medical procedure, (ii) electronically enables the subject to provide an informed consent to the medical procedure, (iii) electronically stores as a medical record for the medical procedure the substance of the informed consent to the medical procedure provided by the subject and documents the manner in which the informed consent was obtained, such that the subject's medical record can be retrieved during a timeout in the medical procedure, and
b. enabling an authorized person who is seeking to review the subject's medical record to access the electronically stored medical record in a manner that documents the authorized person's access of the stored medical record and produces information as to the stored medical record.

5. The method of claim 4, wherein the medical record is produced by selective interface with the subject and the electronic consent component in the following manner:
a. the subject interfaces with an electronic transmission/presentation component that enables the subject to receive and view electronically stored informed consent information related to a medical procedure in an electronically accessible format,
b. the subject electronically interfaces with an informed consent agreement component that enables the subject to (i) electronically acknowledge the informed consent data that has been received and reviewed by the subject with regard to the medical procedure, (ii) electronically provide an informed consent by the subject to the procedure, and (iii) electronically provide to an electronic storage and retrieval component the substance of the informed consent provided by the subject and the manner in which the informed consent was obtained, so that the substance of the informed consent provided by the subject and the manner in which the informed consent was obtained can be electronically stored as a medical record of the subject in connection with the medical procedure; and.
wherein the stored medical record of the subject in connection with the medical procedure is selectively accessible by an authorized person seeking to review the subject's medical record in connection with the medical procedure,

6. The method of claim 5, wherein a medical personnel can selectively interface with the electronic storage and retrieval component at least at one or more of the following points related to the medical procedure:
a. when the subject is admitted to the facility at which the medical procedure will be performed
b. during a timeout while the subject is being prepared for the medical procedure,
c. during a timeout prior to the subject undergoing the medical procedure.

7. The method of claim 4, wherein the electronic consent component is further configured to interact with the subject in a manner that provides the subject with responses to questions submitted by the subject as part of the step of enabling the subject to provide informed consent to the medical procedure.
